(19) United States
(12) Patent Application Publication
(10) Pub. No.: US 2004/0055866 A1
(43) Pub. Date: Mar. 25, 2004

(54) Desalinization still

(76) Inventor: Michael R. Levine, Boca Raton, FL (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/665,457

(22) Filed: Sep. 19, 2003

Related U.S. Application Data
(60) Provisional application No. 60/412,230, filed on Sep. 20, 2002.
(60) Provisional application No. 60/498,083, filed on Aug. 26, 2003.

(51) Int. Cl. B01D 3/10

(52) U.S. Cl. 202/205; 202/182; 202/236

(57) ABSTRACT

A sub-atmospheric pressure desalinating still employs a closed top, opened bottom tank filled with seawater, having a height greater than the height of a column of seawater that can be supported by the pressure at the bottom tank so that a vacuum is formed at the top. A compressor draws vapor from the evacuated area, compresses it and passes it through a heat exchanger within the tank volume to condense the vapor in the tank to generate purified water. Replenishing water is drawn in through the bottom of the tank, passes through a heat exchanger, and is pumped through a heat exchanger coil surrounding the compressor, with the outlet feeding a spray head within the vacuum volume. The compressor and the pump for the intake flow are powered by a wind turbine or wave power.

RELATED APPLICATION

This application claims priority of U.S. Provisional Patent Application Serial No. 60/412,230 filed Sep. 20, 2002, and U.S. Provisional Patent Application Serial No. 60/498,083 filed Aug. 26, 2003, which are incorporated herein by reference.

### BACKGROUND OF THE INVENTION

1. Field of the Invention

This invention relates to a system for distilling seawater or polluted water to produce fresh water, and more particularly to such a system which is low in cost and can be operated directly from a natural power source such as wind power and wave power.

2. Background Art

A number of devices and methods have been utilized to purify seawater and brackish water to produce water of lower salinity for irrigation or drinking purposes. Because of the complexity and high-power requirements of these systems they have had only limited commercial application in specialized areas, such as on ships, in deserts and the like, and have generally produced low quantities of purified water. To lower the cost of the power applied to such desalinators, it has been proposed that natural, renewable energy sources such as wind power, solar power or wave power be used to drive the systems. U.S. Pat. No. 4,555,307 discloses a desalinator powered by a piston engine compressor driven by wave power. Devices of this type are relatively complex and require continuous maintenance.

U.S. Pat. No. 6,436,242 discloses a water distiller using a sub-atmospheric boiler which employs a vacuum pump to reduce the pressure at the top of a tank below that of the atmosphere. The system additionally employs a compressor for the vapor which is presumably powered from an external power supply.

### SUMMARY OF THE INVENTION

The present invention is directed toward a desalinator powered by natural, renewable sources, which is extremely simple so as to be low in initial cost and maintenance-free.

The system of the present invention utilizes a sub-atmospheric still in which the low-pressure is preferably obtained by a liquid column within a tank closed at its top and opened at its bottom to a body of seawater or brine and having a vertical height greater than the height of a column of seawater that can be supported by the atmospheric and liquid pressure that is exerted on the bottom of the column, so that a Toricellian vacuum is created at the top of the column. The seawater at the top of the column boils or evaporates into this vacuum. Vapor in the vacuum area is drawn off by a pump that is powered by a natural, renewable source, preferably a wind turbine or, alternatively, a wave action pump.

These natural power sources are inherently intermittent. There are periods when there is very little wind or wave action, and the pump only operates during those periods when there is sufficient natural power. Thus, the still of the present invention operates on an intermittent basis and only produces purified water when it is operating.

A compressor pump draws vapor from the vacuum volume at the top of the tank and provides its output through a first heat exchanger disposed within the seawater still column. The vapor, heated as a result of the compression, transfers thermal energy to the relatively cooled seawater in the still column. The liquid in the vapor also condenses, liberating heat which is transferred to the seawater in the column. The condensed vapor represents highly purified water which may flow to a reservoir, either directly or through a controlled valve.

As the saltwater in the column is boiled into the vacuum at the top, the resultant highly saline brine, which is heavier than seawater, will tend to fall through the column. Alternatively, it may be collected and dried to produce salt and other minerals.

The vapor that boils off the top of the column is replenished by fresh seawater drawn through a second heat exchanger that has its lower end extending into seawater below the bottom of the tank, and extends upwardly through the still column to a height above the level of seawater in the column. A pump powers seawater from the heat exchanger into the vacuum area, through a spray nozzle, in a volume greater than required to replenish the seawater boiled off the top of the column. As the input tube passes through the still column, it is preheated. The input pump may be powered by a natural source such as a wind turbine or wave action motor. As the added seawater, which does not vaporize, falls into the column, it tends to force the heavier brine out the bottom and rinses the tank to prevent the accumulation of brine.

One of the shortcomings of intermittent natural power sources is the need to accumulate the power that they generate. In the case of the present invention, this is effectively stored in the purified water, finessing the negative effects of an intermittent power source in most other applications.

The still column of the present invention could be supported directly on the bottom of a body of water to be purified. It would provide a low-cost, relatively maintenance-free system with virtually no external power requirements. A series of these stills could be positioned along the coast in the same manner that wind turbines are located in areas of high wind velocity and their fresh water outputs could be pooled to form a relatively high volume source.

Other objects, advantages and applications of the invention will be made apparent by the following description of the preferred embodiment of the invention. The description makes reference to the accompanying drawings in which:

### BRIEF DESCRIPTION OF THE DRAWING

FIG. 1 is a schematic diagram of a preferred embodiment of my invention.

### DETAILED DESCRIPTION OF THE DRAWING

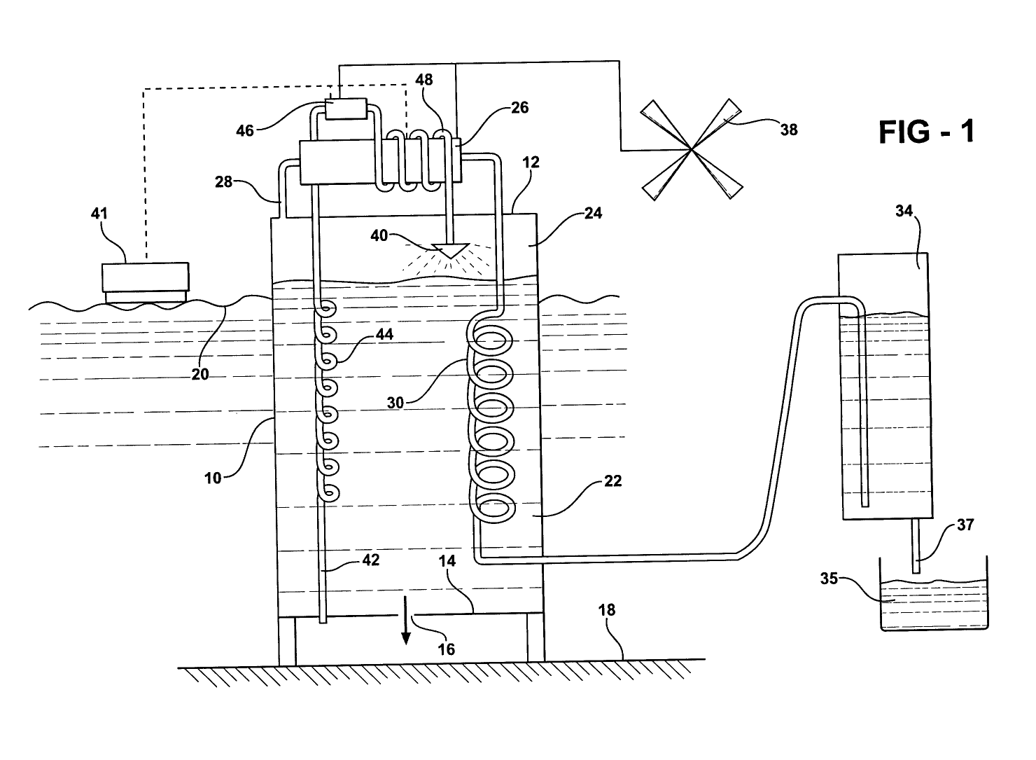

Referring to FIG. 1, the desalinization still of the present invention employs a tank 10 having a closed top 12 and a bottom 14 with an aperture 16. The tank 10 is preferably disposed on the bed 18 of an ocean or other body of brackish or saltwater. The free, mean level of a body of water is indicated at 20.

The tank 10 preferably has a height in excess of 10 meters, such as 13 meters. The tank 10 is filled with saltwater in such a way that a column of water 22 fills most of the body of the tank with the Toricellian vacuum area 24 existing at the top of the tank because the height of the column of the water 22 is greater than can be supported by the combined atmospheric and water pressure at the opening 16.

The vacuum in the area of the volume 24 induces the upper surface of the seawater column 22 in the tank 10 to vaporize and produce sub-atmospheric boiling.

A compressor 26 draws the vapor from the volume 24 through a tube 28, compresses it, and feeds it out through a heat exchanger coil 30. The coil 30 passes through the upper two-thirds of the seawater volume 22 within the tank 10. The compression of the vapor within the coil 30 raises its temperature and it exchanges heat with the relatively cool seawater 22 in the tank. As the vapor cools, it condenses and gives up its heat of vaporization to the water 22. This heating of the seawater increases the vaporization into the volume 24. The condensed water at the bottom of the coil 30, along with exhausted air and other gases is pumped up to a retainer pond 34 which feeds a reservoir 35, where the relatively pure water is stored and the gases are given up to the atmosphere, through a valve 37. By varying the height of the water level in pond 34, through control of the valve 37, the back pressure on the compressor 26 and the temperature of the pumped vapor may be adjusted.

The compressor 26 is preferably mechanically powered by a wind turbine 38. Alternatively, it may be powered by a wave motor 41. These mechanical outputs are directly connected to the compressor 26 for pass-through a gear box (not shown).

A seawater spray is introduced into the volume 24 by a spray head 40. The spray replenishes the vaporized seawater and provides additional water which rinses brine from the hear exchanger. Seawater for the spray head is drawn through a tube 42 at the bottom of the tank 10 and then through a heat exchanger coil 44 which preheats the incoming seawater from the heated water 22 in the tank 10. The output of the inflow heat exchanger 44 passes to a pump 46 which is also mechanically driven by the wind turbine 38 or, alternatively, the wave motor 40. Since water will fill the heat exchanger to 44 to the height of sea level 20 without any pumping force, only a relatively low pumping force is required to pump any desired volume through the spray head 40 so the portion of the main power generated by the air turbine or wave motor can be delivered to the compressor 26. The preheated seawater then passes through a heat exchanger coil 48 which surrounds the compressor 26 so as to pick up the heat generated by its friction to further preheat the saltwater, before passing it to the spray head 40 within the volume 24.

Some of the small droplets produced by the spray head 40 will flash or evaporate, producing additional vapor which is passed out through the tube 28. The compressor 46 will preferably provide a greater flow volume than can be evaporated. The balance of the saltwater will pass into the volume 22 rinsing the brine from the heat exchanger coils 30 and 44.

As the brine within the volume 22 is heated by exchange with the coil 30, the warmer portion tends to rise toward the top end and the colder fluid tends to drop. Similarly, as seawater at the surface of the volume 24 vaporizes, it increases in salinity, becomes heavier and tends to drop. This cold, heavy flow escapes to the seawater through the hole 16 in the bottom of the tank 10, automatically maintaining a constant volume of vacuum 24 at the top of the tank, independent of the rate of replenishment through the spray nozzle 40.

The tank 10 may be initially filled with a seawater volume 22 through the pumping action of the compressor 46 which draws seawater in through the tube 42 and the heat exchanger 44 and outputs it through the spray 40. Alternatively, the tank may be artificially filled from the top and/or may be inverted in the seawater until filled, and then rotated to an upright position to create the vacuum area 24 at the top of the tank 10. The heat exchanger 30 is preferably initially filled with fresh water.

Having thus described my invention I claim:

1. A sub-atmospheric water desalinization still, comprising:
a closed top tank having the lower part of the tank filled with water to be distilled in the sub-atmospheric vacuum at the top of the tank above the water level within the tank so that water to be distilled vaporizes into the vacuum area;
a heat exchanger disposed within the tank;
a compressor having its inlet connected to the vacuum area and having its outlet connected to the heat exchanger; and
a natural force powered source powering the compression, whereby the vapor in the vacuum area is compressed and cooled in the heat exchanger to produce relatively pure water.

2. The still of claim 1 wherein the natural force comprises wind power driving a wind turbine which drives the compressor.

3. The still of claim 1 wherein the natural force comprises wave power which drives a wave power motor which drives the compressor.

4. The still of claim 1 including a second heat exchanger within the tank having one end connected to a source of water to be distilled and the other end connected to the vacuum volume within the tank and a pump forcing water to be distilled through the heat exchanger and into the vacuum volume within the tank.

5. The still of claim 4 wherein the flow volume through the second heat exchanger is greater than required to replenish the tank as a result of vaporization.

6. The still of claim 5 including a spray head feeding the water passing through the second heat exchanger into the vacuum area.

7. A sub-atmospheric water desalinization still, comprising:
a closed top tank;
means for filling the lower part of the tank with water to be distilled;
a vacuum at the top end of the tank in the volume above the water level within the tank so that seawater vaporizes into the vacuum area;
a first heat exchanger disposed within the tank;
a compressor for pumping vapor from the vacuum area at the top of the tank through the heat exchanger to a sump for distilled water;
a second heat exchanger within the volume of water in the tank;
a connection between second heat exchanger and a source of water to be distilled; and
a connection between the other end of the second heat exchanger and the vacuum volume within the tank to replenish the vaporized water in the tank and rinse the heat exchangers.

8. The still of claim 7 in which the tank has an opened ended bottom disposed within the source of water to be distilled and the tank has a greater height than the height of a body of water to be distilled which can be supported by the pressure at the bottom of the tank so as to create said vacuum area at the top of the tank.

9. The still of claim 7 including a wind turbine powering the flow through said first and second heat exchangers.

10. The still of claim 7 including a wave-powered motor for powering the passage of vapor from the vacuum area through the first heat exchanger.
